(19) United States
(12) Patent Application Publication
(10) Pub. No.: US 2016/0233555 A1
(43) Pub. Date: Aug. 11, 2016

(54) BATTERY PROTECTION SYSTEM AND METHOD

(71) Applicant: Physical Sciences, Inc., Andover, MA (US)

(72) Inventors: Daniel F. Pedtke, Shirley, MA (US); Devin T. Mullen, Henniker, NH (US)

(73) Assignee: Physical Sciences, Inc.

(21) Appl. No.: 14/619,461

(22) Filed: Feb. 11, 2015

(51) Int. Cl. H01M 10/42; H01M 2/34

(52) U.S. Cl. CPC H01M 10/4257; H01M 2/34; H01M 2010/4271; H01M 2200/00

(57) ABSTRACT

A battery protection system includes at least a first fuse arranged for connection in series between a load/charger and one or more cells. A shunt switch is connected on the load side of the first fuse. A control subsystem features logic which monitors the cell voltages, determines when any cell voltage is above a predetermined level, and closes the switch causing the first fuse to blow when the cell voltage is above the predetermined level to prevent overheating, a rupture, or an explosion.

### FIELD OF THE INVENTION

This invention relates, in one example, to a system and method for protecting against overheating, rupture, or explosion of a battery pack.

### BACKGROUND OF THE INVENTION

Numerous devices, products, and systems are powered by a battery pack. A battery pack may include several cells in series. Rechargeable lithium ion batteries, in particular, are preferred because they have a high energy density. But, such batteries can overheat, rupture, or even explode if shorted or overcharged. Restrictions regarding the transportation of certain battery packs have been proposed and/or implemented as a result.

Recently, the United Nations created international recommendations for the design of battery packs and defined tests which must be passed by these batteries before they will be certified for public transportation. See also 49 C.F.R. §1.73.185 (shipping requirements for hazardous materials). Section 38 of the “UN Recommendations on the Transport of Dangerous Goods” is a manual of tests and criteria which batteries must meet in order to be certified for public transport on certain carriers (such as aircraft and ships). A subsection of this document applies to lithium metal and lithium ion batteries (§38.3). In that subsection, eight tests are defined which must be applied to battery products in various forms. Tests 1-4 and 6 are of a mechanical nature (Altitude, Thermal, Vibration, Shock, and Impact/Crush, respectively). Tests 5, 7, and 8 are electrical (Short, Overcharge, and Forced Discharge, respectively).

The test descriptions in this UN document are minimal and many details are not clarified. There is no mention of “Following the manufacturer's instructions” which might allow for individual situations to be handled differently. There have been many interpretations by vendors on how to design battery electronics to meet these requirements, some with arguable qualifications on actually meeting the intent of the document. For instance, one can set up a simple circuit that will meet the requirements using two connectors on the battery, one for charge and one for discharge. The rules are met if test 7 is applied to the charge connector but such a circuit will not pass if test 7 is applied to the discharge connector. The recommendations do not address such a situation.

### SUMMARY OF THE INVENTION

In the subject invention, a battery is disabled automatically if an overcharge condition exists. At the same time, the battery protection system is low cost, small, lightweight, and functions with minimal degradation of battery performance under load and yet the preferred battery protection system is designed to pass the UN §38.3 criteria and tests without compromising the performance of the battery. Protection against short circuits is also provided.

Featured is a battery protection system comprising a series connection of at least a first fuse, a load/charger, and at least one cell. The cell powers the load. The charger charges the cell. A shunt switch is connected on the load/charger side of the first fuse. A control subsystem is configured to monitor the at least one cell voltage, determine when the cell voltage is above a predetermined level and close the switch causing the first fuse to blow when the cell voltage is above the predetermined level.

The first fuse may be connected in series with a positive or negative terminal of a connector which couples to a load or charging device.

The system may further include a second fuse in series with the first fuse between the shunt switch and the load. The system may further include a power storage device charged by at least one cell and configured to supply power to the control subsystem. A voltage reference circuit, if included, is configured to provide a reference voltage to the control subsystem. The control subsystem may be calibrated based on the reference voltage. The system may further include a balancing connector.

Also featured is a battery protection method including arranging at least a first fuse in connection between a load and at least one cell powering the load, connecting a shunt switch on the load side of the first fuse, monitoring at least one cell voltage, determining when the monitored cell voltage is above a predetermined level, and closing the switch causing the first fuse to blow when the cell voltage is above the predetermined level to disconnect the battery from an overcharging source.

One battery protection system includes a plurality of cells connected in series with a first connection to a first terminal of a connector through first and second fuses. A shunt switch is connected between the first and second fuses and a second terminal of the connector and a second connection to the cells. A control subsystem is programmed to monitor the cell voltages, determine when a cell voltage is above a predetermined level, and close the switch causing the first fuse to blow when a cell voltage is above the predetermined level.

One system for protecting a battery includes at least one cell connected to a charger/load connector. There is preferably a direct circuit from the positive side of the cell to the negative side of the cell including a fuse and a switch. One terminal of the connector is connected to the fuse. A processor is connected to the cells and monitors the cell voltages. The processor is configured to close the switch to blow the fuse when a cell voltage is above a predetermined level.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a block diagram showing a battery protection system incorporated on a battery pack in accordance with one example of the invention;

FIG. 2 is a block diagram showing, in one example, the primary components associated with the battery protection system of FIG. 1;

FIG. 3 is a block diagram showing, in one example, the primary components associated with the control subsystem of FIG. 2; and

FIG. 4 is a flow chart depicting the primary steps associated with the programming of the microprocessor shown in FIG. 3 and also associated with one preferred method of the invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

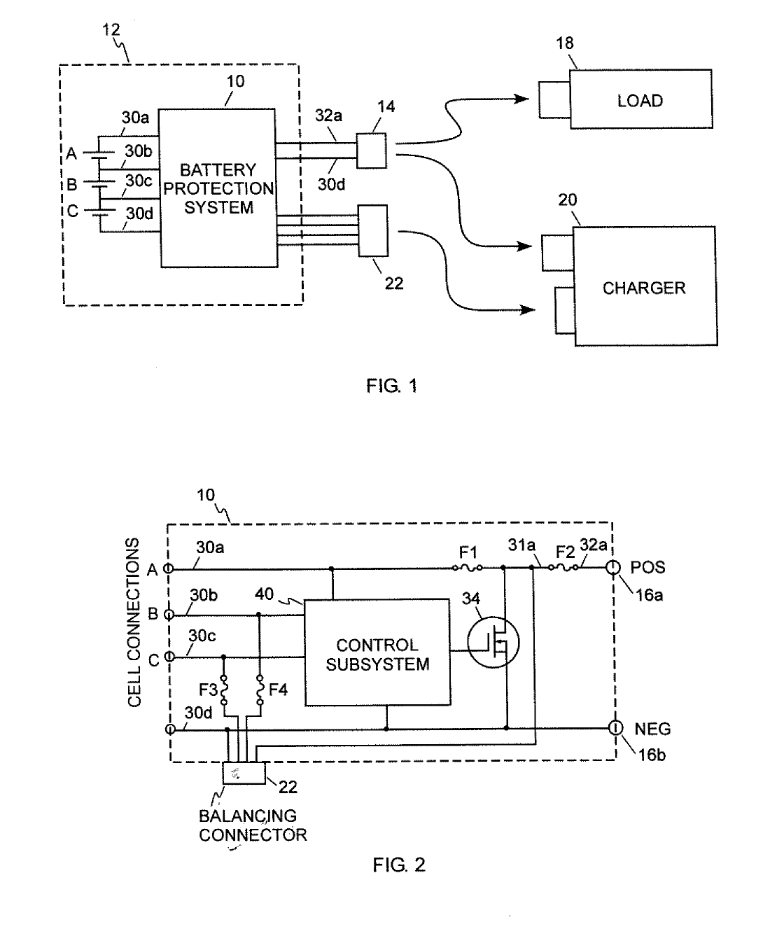

Battery protection system 10, FIG. 1 may be implemented on a printed circuit board to be attached to a battery pack, in one example, shown at 12 with individual cells A, B, and C connected in series. In other examples, there are more or less cells. The battery pack may include lithium metal, lithium ion, or other type cells.

The cells A, B, and C are connected to power/charger connector 14 with a positive 16a terminal and a negative 16b terminal as shown in FIG. 2 to be connected to a load 18, FIG. 1 powered by the battery pack. In but one example, the load 18 is a robot or unmanned aerial vehicle. Connector 14 can also be connected to charger 20 for charging battery pack 12. In some designs, a balancing connector 22 is also included and connected to charger 20 during charging of the battery pack.

Protection system 10, FIG. 2 includes at least first fuse F₁ arranged in series between a load/charger and at least one cell. In one example, F₁ is disposed in line 30a ultimately connected to the positive terminal 16a of the connector 14, FIG. 1 to be connected to load 18 and charger 20. Line 30a is also connected to the cell A as shown in FIG. 1. Fuse F₁ could instead be disposed in the common or negative line 30d, FIG. 2. Fuse F₁ may be replaceable in some versions.

Shunt switch 34 (shown here as a power FET) is connected on the load or connector side of fuse F₁ as shown in FIG. 2 between lines 31a and 30d. Other switching devices may be employed. Fuse F₂, if included, is connected in series with fuse F1 between lines 31a and 32a. Line 31a connects to fuse F₁ and line 32a connects to positive terminal 16a of connection 14, FIG. 1. The operation of fuse F₂ is discussed below.

Control subsystem 40 is configured to control switch 34 and to automatically turn it on when certain conditions are met. When switch 34 is turned on, fuse F₁ blows. With fuse F₁ blown, there is an open circuit between charger 20, FIG. 1 connected to connector 14 and cells A, B, and C. Preferably, switch 34 is closed automatically when an overcharge condition is detected. Thus, the cells are protected from further overcharging.

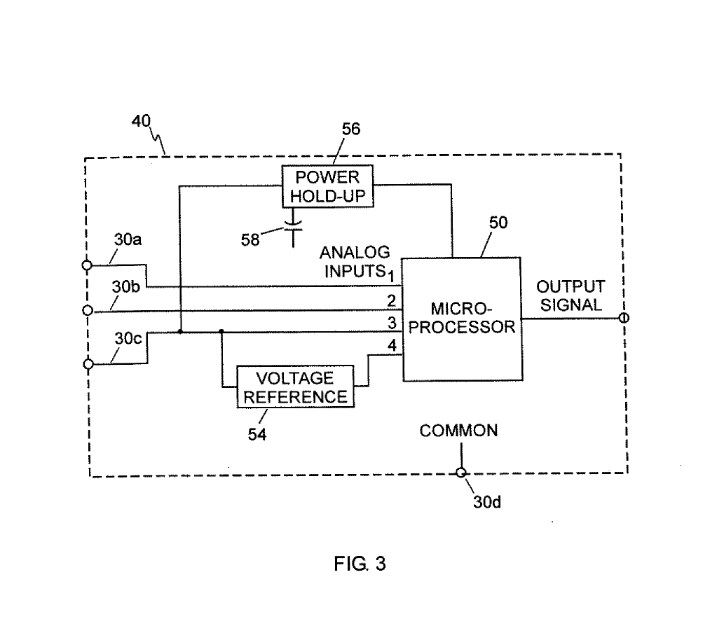

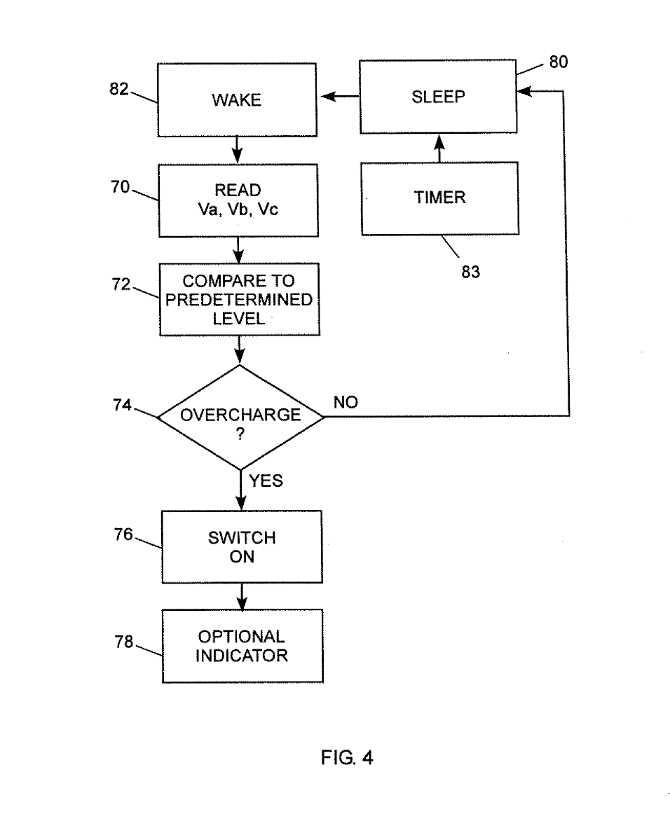

Control subsystem 40 may include a microprocessor, field programmable gate array, application specific integrated circuit, a controller, or similar circuitry preferably running computer instructions as described below. Equivalent analog circuitry may also be used. In the version shown in FIG. 3, microprocessor 50 inputs 1, 2, and 3 are used to monitor the cell voltages, step 70. FIG. 4. In this particular example there are three cells connected in series in order to obtain a higher voltage and the individual connections of the cells are brought to microprocessor 50. The terminal on line 30c is the top or positive side of the first cell in the series connected to the microprocessor input 3 and to the bottom (negative) of the second cell. The negative of this first cell is connected to a circuit common point usually referred to as the return or common or ground point of a circuit shown here as 30d. This common is connected to all the devices of the circuitry even though those connections are not depicted in FIG. 3. The second microprocessor connection connects to the top (positive) side of the second cell and the bottom (negative) side of third cell. Likewise the other microprocessor connection is to the top of the third cell which is also the main positive output connection point of the battery going to the main connector 14, FIG. 2 through fuse F₁ and optional fuse F₂.

In this way, the voltage levels of the individual cells can be monitored by microprocessor 50. Averaging techniques may be used to account for transient voltages on the battery. Each voltage level, for example, may be read several times before a comparison is made to a predetermined voltage level, step 72, FIG. 4. This predetermined voltage level may be stored in memory. In one example, if a cell voltage is normally 4.2 volts at full charge, the stored threshold may be 4.4 volts which, if reached, indicates in an overcharge condition, step 74, FIG. 4. When an overcharge condition is detected for any cell, microprocessor 50, FIG. 3 functions to output a signal which closes (turns on) switch 34, FIG. 2, step 76, FIG. 4. Fuse F₁, FIG. 2 then blows and the battery is disconnected from the overcharging source preventing overheating, rupture, and/or an explosion.

Turning switch 34 on allows electric current to flow from the positive side of the cells through fuse F₁, through switch 34, and then back to the negative side of the cells. This direct path across the cells of the battery produces a very high current which will quickly blow fuse F₁. Then, the cells are disconnected from the terminals 16a and 16b of the power/charger connector 14, FIG. 1 which will prevent overcharging damage to the battery cells. In one example, fuse F₁ may be rated at 30 amps and the current capability of the cells is over 100 amps so that fuse F₁ would quickly blow when switch 34 is activated.

An optional indicator (e.g., a lamp) may be provided and activated (e.g., illuminated), step 78, FIG. 4 to provide an indication that fuse F₁, FIG. 2 is blown and requires replacing. In other embodiments, fuse F₁ is resettable via control subsystem 40.

To save power, microprocessor 50, FIG. 3 may be programmed to sleep periodically, step 80, FIG. 4 and then wake at shown at step 82, based on timer 83. For example, the microprocessor 50, FIG. 3 could read the voltages and carry out steps 70-74, FIG. 4 which consumes less than 1 second and then sleep for a longer time such as 15 seconds to reduce energy consumption. This duty cycle results in greatly reduced average power consumption by the monitoring system.

Second fuse F₂, FIG. 2 may be provided in series with first fuse F₁ between shunt switch 34 and the load/charger. Fuse F₂, while optional, provides further improvement in some unusual circumstances which might occur in use of a battery pack. As described above, the basic action of switch 34 is to provide a controlled high current path from the battery through fuse F₁ to intentionally blow fuse F₁. When switch 34 is activated, there is also the possibility of a high current path between the connections 16a, 16b and switch 34 if terminals 16a and 16b are connected to a high current source. F₂ is inside this path. If a user connects the battery pack to a high current power source (e.g., a car battery) externally through the power/charge connector 14, FIG. 1, such a high current source might over-power switch 34 and prevent it from working properly. With fuse F₂ included, switch 34 will serve the function of blowing fuse F₁ from energy from the included battery cells. Fuse F₂ blows with energy supplied by an external high current source. Thus, no matter what is connected externally, switch 34 will still effectively serve its purpose to blow fuse F₁.

Note too the connection from the cells to the power connector is direct not going through any electronic switches which could introduce losses but only going through both fuses F₁ and F₂. One advantage of this design is that no other electronic components are in the path between the battery cells and the connection to the product load. Fuses are very low resistance devices that have little impact on the power going through them unless the current is too high. Fuses do not present any significant reduction of performance compared to a battery with electronic series switches.

The balancing connector 22, FIG. 1, may be used by the charger 20 to assure that all the cells of the battery are equally charged. Using connections to each cell, as shown, the charger 20 can check individual cell voltage and charge any cells that are below a predetermined voltage and discharge any cells that are above the predetermined voltage. This connector is connected directly to the battery cells through fuses F₁, F₃, and F₄, FIG. 2. These fuses are meant to protect the battery should a short occur on any of the terminals of this connector 22 to other terminals, or to the terminals of power connector 14. Some safety testing includes overcurrent tests on the balancing connector 22, and these fuses serve to meet the requirements of these tests.

Microprocessor 50, FIG. 3 is preferably chosen to have the capability to execute software which is permanently programmed into the part as well as the capability to read voltages and preferably includes an Analog-To-Digital Converter (ADC) for this purpose. In FIG. 3, the microprocessor chip is shown with four voltage inputs on the left side, labeled 1, 2, 3, and 4. This provides a way to measure the voltage on each of the battery cells as well as an optional voltage reference device 54 which provides a precise voltage level to processor 50. The microprocessor with an ADC is capable of measuring the voltages on its pins to some degree of accuracy as specified by the manufacturer of the chip. The accuracy should be high enough to make a positive determination of the overvoltage state of the cells. In one example, a lower cost system can be produced if a microprocessor chip with low accuracy voltage measurement capability is used and an external highly accurate voltage reference IC 54 is included in the design. In this case, the microprocessor measures the three cell voltages and uses the reference voltage for calibration thus maintaining the accuracy needed to determine an overcharge state.

In one example, the reference voltage is V_{ref} and the processor 50 reads on pin 4 V_{ref1}. The logic of the processor thus adjusts its reading of the voltage levels read from the cells by a correction factor based on the difference between V_{ref} and V_{ref1}. It would be equally effective to use a microprocessor with an internal voltage reference of high accuracy. Also, there are several other possible implementations whereby a voltage can be read accurately.

In one example, a small amount of energy is taken from the cells of the battery pack to power the control or microprocessor system. Other possible implementations could power the microprocessor system from a different battery or other external power source. The optional power hold-up device 56 serves to regulate power and to also maintain power during a fuse blow event when the microprocessor is powered by the cells of the battery being protected. Though it is convenient to use the power from one of the battery cells of the pack to power microprocessor system 50, there is a disadvantage which becomes evident in some modes of operation. During the very short time when the fuse is being blown, the voltage on the battery can be reduced due to the high energy required to blow the fuse. If the cells of the battery pack are near the end of their discharge life (near the point where recharge is required) the voltage on the cells may fall to a point where the microprocessor 50 may not be able to function properly. The power hold-up circuit 56 solves this problem through use of a storage device such as capacitor 58 shown in FIG. 3. This capacitor can be charged with energy from the cells for use at a later time when the microprocessor system runs to determine the overcharge state of the cells and possibly blows fuse, F₁, FIG. 2. The power hold-up circuit 56 is therefore an improvement in operation of the invention but the invention can be implemented without it.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A battery protection system comprising:
a first fuse arranged for connection in series between a load and at least one cell of the battery;
a shunt switch connected on the load side of the first fuse; and
a control subsystem configured to:
monitor the at least one cell voltage,
determine when said cell voltage is above a predetermined level, and
close the switch causing a first fuse to blow when the cell voltage is above said predetermined level.

2. The system of claim 1 in which the first fuse is connected to a positive or negative terminal of a battery connector.

3. The system of claim 1 further including a second fuse in series with the first fuse between the shunt switch and the load.

4. The system of claim 1 further including a power storage device charged by at least one cell and configured to supply power to the control subsystem.

5. The system of claim 1 further including a voltage reference circuit configured to provide a reference voltage to the control subsystem.

6. The system of claim 5 in which the control subsystem is calibrated based on the reference voltage.

7. A battery protection method comprising:
arranging a first fuse for connection in series between a load and at least one cell of the battery;
connecting a switch on the load side of the first fuse;
monitoring the at least one cell voltage;
determining when the monitored cell voltage is above a predetermined level; and
closing the switch causing the first fuse to blow when the cell voltage is above said predetermined level.

8. The method of claim 7 in which there are a plurality of cells connected in series.

9. The method of claim 7 in which the first fuse is connected to a positive or negative terminal of a battery connector.

10. The method of claim 7 further including arranging a second fuse in series with the first fuse between the shunt switch and the load.

11. The method of claim 7 in which monitoring at least one cell voltage includes using a voltage reference.

12. A battery protection system comprising:
a plurality of cells connected in series with a first connection to a first terminal of a battery connector through a first fuse and a second fuse;
a shunt switch connected between the first fuse and second fuse and connected to a second terminal of the connector and a second connection to the cells; and
a control subsystem connected to the cells and to the shunt switch, the control subsystem configured to:
monitor the cell voltages,
determine when a cell voltage is above a predetermined level, and
close the switch causing the first fuse to blow when a cell voltage is above the predetermined level.

13. A system for protecting a battery including at least one cell connected to a charger/load connector, the system comprising:
a direct circuit from the positive side of the cell to the negative side of the cell including a fuse and a switch;
one terminal of the connector connected to the fuse;
a processor connected to the cells for monitoring the cell voltages; and
the processor configured to close the switch to blow the fuse when a cell voltage is above a predetermined level.
